(19) United States
(12) Patent Application Publication
(10) Pub. No.: US 2009/0059372 A1
(43) Pub. Date: Mar. 5, 2009

(54) OPTICAL IMAGE STABILIZER

(75) Inventors: Takahiro Kawauchi, Fukushima-ken (JP); Akihito Yamamoto, Fukushima-ken (JP); Toru Sawada, Fukushima-ken (JP)

Correspondence Address: HUNTON & WILLIAMS LLP;INTELLECTUAL PROPERTY DEPARTMENT, 1900 K STREET, N.W., SUITE 1200, WASHINGTON, DC, 20006-1109, US

(73) Assignee: ALPS ELECTRIC CO., LTD, Tokyo (JP)

(21) Appl. No.: 12/198,337

(22) Filed: Aug. 26, 2008

(30) Foreign Application Priority Data
Aug. 28, 2007 (JP) 2007-221242

(51) Int. Cl. G02B 27/64

(52) U.S. Cl. 359/554; 396/52

(57) ABSTRACT

Disclosed is an optical image stabilizer having a low sliding load, a smooth operation, and a small thickness. When a lens holder and an X slider are moved in the X direction, small balls roll between the side surface of the lens holder and the inner surface of a frame of a Y slider, thereby reducing a sliding load therebetween. When the lens holder and the Y slider are moved in the X direction, small balls roll between the side surface of the lens holder and the inner surface of the frame of the X slider, thereby reducing a sliding load therebetween. Therefore, it is possible to achieve an optical image stabilizer having low power consumption, a smooth operation, and high responsibility. In addition, the thickness of the lens holder is equal to or smaller than the sum of the thicknesses of the X slider and the Y slider overlapped with each other. Therefore, it is possible to achieve an optical image stabilizer having a small thickness.

This application claims priority to the Japanese Patent Application No. 2007-221242, filed Aug. 28, 2007, the entirety of which is hereby incorporated herein by reference.

### BACKGROUND OF THE DISCLOSURE

1. Technical Field

The present invention relates to an optical image stabilizer provided in, for example, digital cameras, and more particularly, to an optical image stabilizer that has a small sliding load, a smooth operation, and a small thickness.

2. Related Art

In general, optical image stabilizers have been provided in electronic cameras. A technique has been proposed which performs image stabilization by moving a correction optical system in two directions (a pitch direction and a yaw direction) orthogonal to an optical axis in the optical image stabilizer, as disclosed in JP-A-3-188430, JP-A-7-28117, and JP-A-2003-330055.

In the technique disclosed JP-A-3-188430, a lens holding frame is floatably supported in the pitch direction by a first holding frame, and a second holding frame floatably supports the first holding frame in the yaw direction. The first and second holding frames are driven by an electromagnetic force generated by a current flowing through a coil and a magnet.

The technique disclosed in JP-A-7-28117 uses the rotating force of a motor. The technique converts the rotational motion of two shafts into a rectilinear motion and shifts a lens holder in a direction orthogonal to the optical axis.

In the technique disclosed in JP-A-2003-330055, a pitching moving frame and a yawing moving frame are driven by electronic actuators.

However, in the technique disclosed in JP-A-3-188430, coil springs are provided at both ends of the shaft, and the lens holding frame is maintained at a neutral position by the balance of an elastic force. Therefore, a driving force that is stronger than the elastic force of the coil spring is needed to operate the lens holding frame. As a result, it is difficult to smoothly move the lens holding frame and a large amount of current is needed to operate the lens holding frame.

In the technique disclosed in JP-A-7-28117, a reduction gear train is used to convert the rotating force of the motor into a rectilinear motion. Therefore, this structure has low energy efficiency and high power consumption. In addition, it is difficult to reduce a load due to friction, and it is difficult to correspond to a high frequency, which results in low responsibility.

The technique disclosed in JP-A-2003-330055 uses the electronic actuators in order to reduce power consumption and improve responsiveness. However, when moving the pitching moving frame in the pitching direction, it is necessary to move the yawing moving frame together with the pitching moving frame. Therefore, since a large load is applied, it is difficult to reduce power consumption and improve the responsiveness. In addition, the pitching moving frame equipped with a lens is provided on the yawing moving frame so as overlap each other. Therefore, the thickness of the moving frames increases, and thus it is difficult to reduce the thickness and the size of an apparatus.

These and other drawbacks exist.

### SUMMARY OF THE DISCLOSURE

An advantage of aspects of the disclosure is that it provides an optical image stabilizer having high responsiveness and low power consumption by reducing friction. Another advantage of aspects of the disclosure is that it provides an optical image stabilizer having a small thickness.

According to an aspect of the invention, an optical image stabilizer includes: a lens holder; an X slider that is movable in an X direction while restricting the movement of the lens holder in the X direction; a Y slider that is movable in a Y direction orthogonal to the X direction while restricting the movement of the lens holder in the Y direction; an X driving unit that applies a driving force to move the X slider in an X-axis direction; a Y driving unit that applies a driving force to move the Y slider in a Y-axis direction; and moving members that are provided between the lens holder and the X slider and between the lens holder and the Y slider and move one of the X slider and the Y slider relative to the other slider.

For example, the moving members may be spherical or cylindrical. Alternatively, the moving members may include convex portions that are formed on one of the lens holder and the X or Y slider and a sliding surface that is formed on the other.

In the above-mentioned aspect, when the lens holder and the X slider are moved in the X direction, the moving members may roll between the side surface of the lens holder and the inner surface of the frame of the Y slider, thereby reducing a sliding load therebetween. In addition, when the lens holder and the Y slider are moved in the Y direction, the moving members may roll between the side surface of the lens holder and the inner surface of the frame of the X slider, thereby reducing a sliding load therebetween. In this way, may be possible to achieve an optical image stabilizer that smoothly operates while consuming low power and has high responsiveness.

In the optical image stabilizer according to the above-mentioned aspect the X slider may include a frame that accommodates the lens holder, and first receiving portions that protrude from the inner surface of the frame inward. The Y slider may include a frame that may accommodate the lens holder, and second receiving portions that protrude from the inner surface of the frame inward. The lens holder may include step portions that may be formed by cutting portions of the side surface thereof, and the moving members may be provided between the first receiving portions of the X slider and the step portions and between the second receiving portions of the Y slider and the step portions.

According to the above-mentioned structure, it may be possible to specify the positions where the moving members are provided during an assembly process, and it may be possible to prevent the moving members from being detached after the assembly process.

In the optical image stabilizer according to the above-mentioned aspect the lens holder may be supported by the X slider and the Y slider that are opposite to each other in the thickness direction thereof while being interposed therebetween. In addition the thickness of the lens holder may be equal to or smaller than the sum of the thicknesses of the X slider and the Y slider.

According to the above-mentioned structure, it may be possible to reduce the thickness of an assembly of the lens holder, the X slider, and the Y slider. As a result, it may be possible to achieve an optical image stabilizer having a small thickness and a small volume.

An optical image stabilizer according to the above-mentioned aspect may further include: X shafts that may guide the X slider in the X direction; and Y shafts that may guide the Y slider in the Y direction. The X shafts and the Y shafts may be opposite to each other with a predetermined distance therebetween in the thickness direction, and the X slider and the Y slider having the lens holder interposed therebetween are provided between the X shafts and the Y shafts.

According to the above-mentioned structure, it may be possible to move the X slider or the Y slider along the shafts in a straight line. In addition, the X shafts face the X slider, and the Y shafts are provided close to the Y slider so as to face the X slider. Therefore, the shafts can restrict the movement of the sliders in the thickness direction. As a result, it may be possible to prevent the assembly from being detached or disassembled after an assembly process.

In the optical image stabilizer according to the above-mentioned aspect, it may be possible to improve responsiveness by reducing friction, and reduce power consumption. Further, it may be possible to achieve an optical image stabilizer having a small thickness.

### BRIEF DESCRIPTION OF THE DRAWINGS

FIG. 1 is an exploded perspective view illustrating an optical image stabilizer according to an embodiment of the disclosure;

FIG. 2 is a plan view illustrating the optical image stabilizer illustrated in FIG. 1;

FIG. 3 is a cross-sectional view taken along the line III-III of FIG. 2;

FIG. 4 is a cross-sectional view taken along the line IV-IV of FIG. 2;

FIG. 5 is a partial cross-sectional view illustrating a lens holder and a slider according to an embodiment of the disclosure; and

FIG. 6 is a block diagram illustrating an exemplary control system of the optical image stabilizer.

### DESCRIPTION OF EXEMPLARY EMBODIMENTS

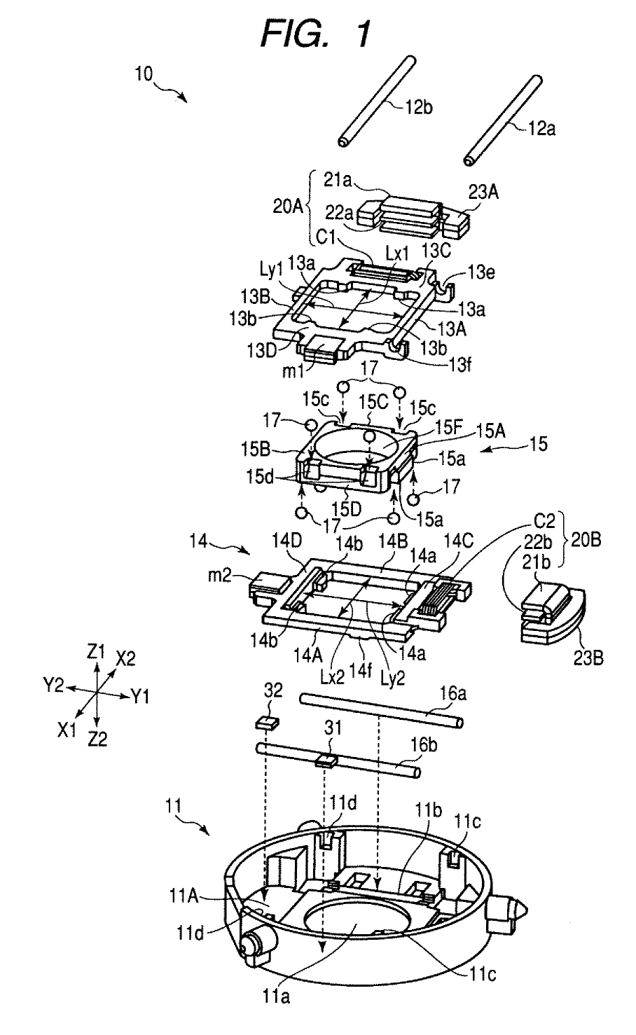

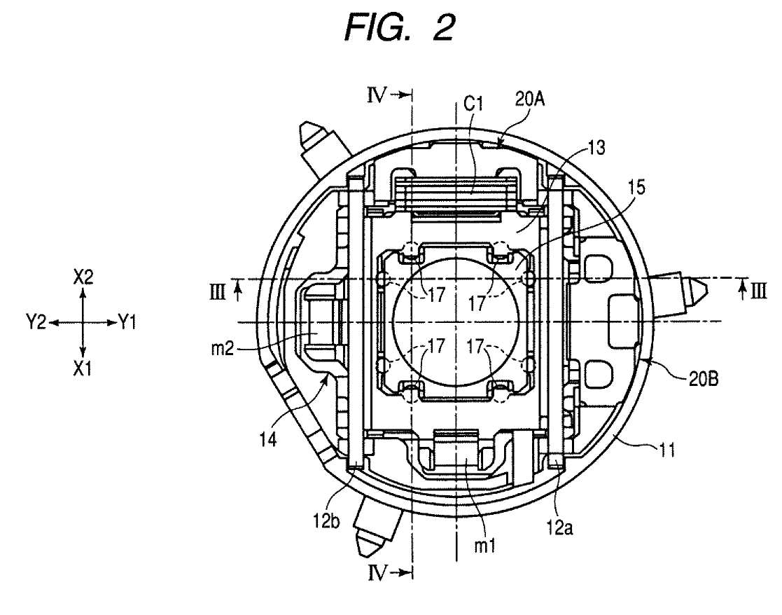

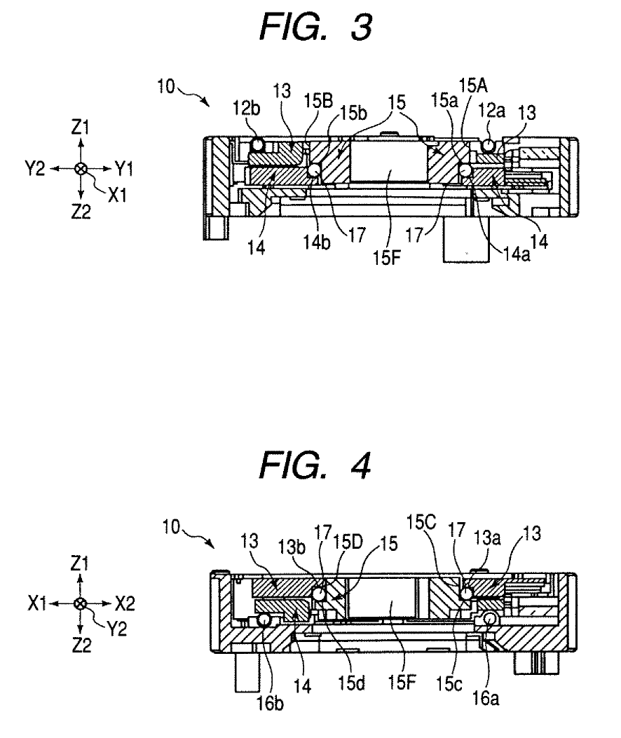

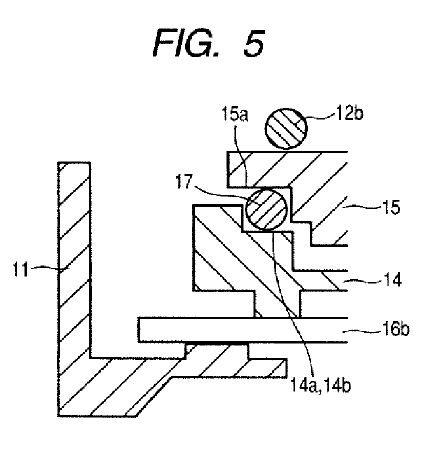

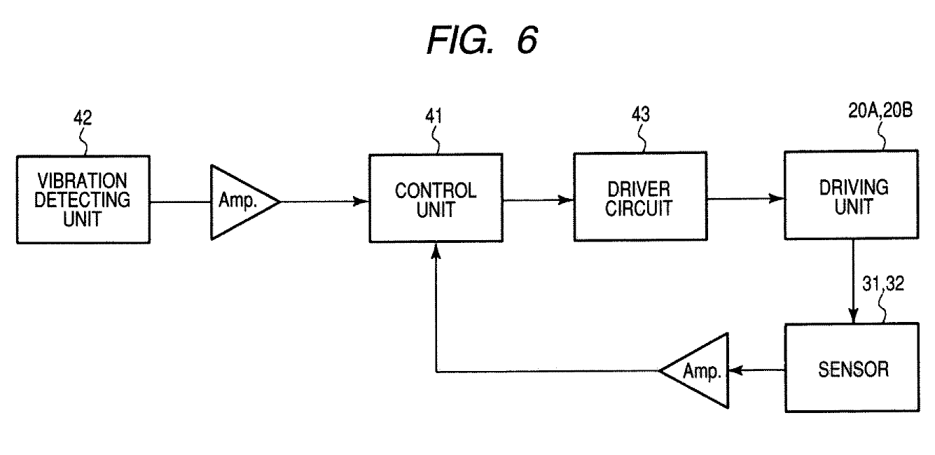

FIG. 1 is an exploded perspective view illustrating an optical image stabilizer according to an embodiment of the disclosure. FIG. 2 is a plan view illustrating the optical image stabilizer. FIG. 3 is a cross-sectional view taken long the line III-III of FIG. 2. FIG. 4 is a cross-sectional view taken along the line IV-IV of FIG. 2. FIG. 5 is a partial cross-sectional view illustrating a lens holder and a slider. FIG. 6 is a block diagram illustrating a control system of the optical image stabilizer.

In the following description, two directions orthogonal to the optical axis of a lens are referred to as an X direction and a Y direction. One of the two directions is a pitch direction, and the other direction is a yaw direction.

FIG. 1 shows an exemplary apparatus for stabilizing the lens provided in an electronic camera. As shown in FIGS. 1 and 2, an optical image stabilizer 10 according to this embodiment may include an assembly of an X slider 13, a Y slider 14, and a lens holder 15. Each of the X slider 13 and the Y slider 14 may be a frame-shaped member (frame) that has at least four side portions surrounding a through hole.

The X slider 13 provided on the Z1 side of FIG. 1 may be a frame-shaped member (frame) having at least four side portions 13A, 13B, 13C, and 13D. The two side portions 13A and 13B may be provided in parallel so as to be opposite to each other with a predetermined gap Lx1 therebetween in the Y direction, and the two side portions 13C and 13D may be provided in parallel so as to be opposite to each other with a predetermined gap Ly1 therebetween in the X direction. The gaps Lx1 and Ly1 satisfy Lx1<Ly1.

The X slider 13 may have a ring-shaped coil C1 wound around the side portion 13C that may be positioned on the X2 side of FIG. 1 and an X detection magnet m1 that may be provided in the side portion 13D positioned on the X1 side to detect position in the X direction. In addition, the coil C1 may be formed by winding a fine coated conductive wire around an X axis in what can be a substantially rectangular shape.

First receiving portions 13a and 13b respectively may be provided in the inner surfaces of the side portions 13C and 13D so as to protrude inward (toward the center of the through hole). That is, the first receiving portions 13a may be provided at both ends of the side portion 13C in the Y1 and Y2 directions, and the first receiving portions 13b may be provided at both ends of the side portion 13D in the Y1 and Y2 directions. The first receiving portions 13a and 13b may be formed so as to have a depth that is half the thickness of the frame-shaped member from the upper surfaces of the side portions 13C and 13D in the Z1 direction of FIG. 1, and step portions may be provided between the lower surfaces of the side portions 13C and 13D and the first receiving portion 13a and 13b, respectively.

Shaft support portions 13e and 13f may be integrally formed with the side portion 13A at both ends of the side portion 13A in the X1 and X2 directions such that they protrude in the Y1 direction. In addition, each of the shaft support portions can have a substantially U shaped end. As will be described below, an X shaft 12a or an X shaft 12b may be supported by the shaft support portions 13e and 13f.

As shown in FIG. 1, the Y slider 14 provided on the Z2 side of FIG. 1 may have the same structure as the X slider 13. That is, the Y slider 14 has at least four side portions 14A, 14B, 14C, and 14D. Among them, the side portion 14A and the side portion 14B may be provided in parallel so as to be opposite to each other with a predetermined gap Lx2 therebetween in the X direction, and the side portions 14C and 14D may be provided in parallel so as to be opposite to each other with a predetermined gap Ly2 therebetween in the Y direction. The gaps Lx2 and Ly2 satisfy Lx2>Ly2.

As shown in FIG. 1, a ring-shaped coil C2 may be provided in the side portion 14C of the Y slider 14 that is positioned in the Y1 direction, and a Y detection magnet m2 that detects position in the Y direction may be provided in the side portion 14D that may be positioned on the Y2 side. In addition, the coil C2 is formed by winding a fine coated conductive wire around a Y axis in a substantially rectangular shape.

Second receiving portions 14a and 14b respectively may be provided in the inner surfaces of the side portions 14C and 14D so as to protrude inward. That is, the second receiving portions 14a may be provided at both ends of the side portion 14C in the X1 and X2 directions, and the second receiving portions 14b may be provided at both ends of the side portion 14D in the X1 and X2 directions.

The second receiving portions 14a and 14b may be formed so as to have a thickness that is approximately half the thickness of the frame-shaped member from the lower surfaces of the side portions 14C and 14D in the Z2 direction of FIG. 1, and step portions may be provided between the upper surfaces of the side portions 14C and 14D and the second receiving portion 14a and 14b, respectively.

Further, a pair of guide pieces 14f that may be interpose the Y shafts 16a and 16b, which will be described below, in both directions (X1 and X2 directions) may be provided on the lower surfaces of the side portions 14A and 14B. The Y shafts 16a and 16b and the pair of guide pieces 14f form a guide unit that guides the Y slider 14 in an approximately straight line in the Y direction.

The lens holder 15 may be provided between the X slider 13 and the Y slider 14. The lens holder 15 is a member having a substantially square shape including four side surfaces 15A, 15B, 15C, and 15D. A generally circular opening 15F may be formed at the center of the lens holder 15 so as to pass through the lens holder in the thickness direction thereof, and a correction optical system (not shown) is provided in the opening 15F. In addition, the length of the lens holder 15 in the X direction may be substantially equal to the gap Lx1 of the X slider 13, but smaller than the gap Lx2 of the Y slider 14. Similarly, the length of the lens holder 15 in the Y direction may be smaller than the gap Ly1 of the X slider 13, but substantially equal to the gap Ly2 of the Y slider 14.

As shown in FIGS. 1 and 3, step portions 15a and step portions 15b (not shown) may be integrally formed with the side surfaces 15A provided on the Y1 side of the drawings and the side portion 15B provided on the Y2 side of the drawings, respectively. The step portions 15a and 15b may be formed between the lower surface of the lens holder 15 and the middle portions of the side surfaces 15A and 15B by cutting the surfaces in generally L shapes in a cross-sectional view.

Similarly, as shown in FIGS. 1 and 4, step portions 15c and step portions 15d may be integrally formed with the side surface 15C provided on the X1 side of the drawings and the side portion 15D provided on the X2 side of the drawings, respectively. The step portions 15c and 15d may be formed between the upper surface of the lens holder 15 and the middle portions of the side surfaces 15C and 15D by cutting the surfaces in generally L shapes in a cross-sectional view.

As shown in FIG. 1, the optical image stabilizer 10 may include a case 11 housing the assembly of the X slider 13, the Y slider 14, and the lens holder 15. An opening 11a may be formed in the bottom 11A of the case 11, and an image may be captured through the opening 11a.

A pair of parallel grooves 11b elongated in the Y direction are formed in the case at positions that are opposite to each other in the X1 and X2 directions with the opening 11a interposed therebetween. The pair of parallel Y shafts 16a and 16b may be fitted to the elongated grooves 11b.

Support concave portions 11c and support concave portions 11d may be formed at four points on the upper edge of the case 11. The X shaft 12a can be supported by the support concave portions 11c, and the X shaft 12b can be supported by the support concave portions 11d.

As shown in FIG. 1, a yoke 21a and a magnet 22a forming a portion of an X driving unit 20A may be provided in a portion of the case 11 that is positioned on the X1 side, and a yoke 21b and a magnet 22b forming a portion of a Y driving unit 20B are provided in another portion of the case 11 that is positioned on the Y1 side. The yoke 21a and the magnet 22a may be provided at a predetermined position of the case 11 in the X1 direction, with being held by a holding member 23A. Similarly, the yoke 21b and the magnet 22b may be provided at a predetermined position of the case 11 in the Y1 direction, with being held by a holding member 23B. The coil C1 may be provided between the yoke 21a and the magnet 22a, and the coil C2 may be provided between the yoke 21b and the magnet 22b.

In addition, magnetic sensors 31 and 32 may be provided at positions on the bottom 11A of the case 11 in the X1 and Y2 directions, respectively. The magnetic sensor 31 can face the X detection magnet m1, and the magnetic sensor 32 can face the Y detection magnet m2.

For example, Hall elements, MRs, or GMRs may be used as the magnetic sensors 31 and 32.

Next, the assembly of the optical image stabilizer 10 will be described. First, the magnetic sensors 31 and 32 may be fixed to the bottom 11A of the case 11. The magnetic sensors 31 and 32 may be mounted to an FPC (not shown). Then, the Y shafts 16a and 16b may be fitted into the elongated grooves 11b. Then, the X slider 13, the Y slider 14, and the lens holder 15 may be assembled.

In the following description, it is assumed that the X detection magnet m1 and the coil C1 have already been mounted to the X slider 13, and the Y detection magnet m2 and the coil C2 have already been mounted to the Y slider 14. In addition, the coils C1 and C2 are connected to a control circuit by an FPC (not shown), and current flow to the coils is controlled by the control circuit.

The lens holder 15 may be provided inside the frames of the upper (Z1 side) X slider 13 and the lower (Z2 side) Y slider 14. As shown in FIGS. 3 and 4, the X slider 13 may be provided on the Y slider 14 so as to overlap with the Y slider, and the thickness of the lens holder 15 may be equal to or smaller than the thickness of the X slider 13 and the Y slider 14 overlapped with each other. Therefore, it may be possible to reduce the thickness and size of the assembly.

As described above, the length of the lens holder 15 in the X direction may be substantially equal to the gap Lx1 of the X slider 13, but smaller than the gap Lx2 of the Y slider 14. Similarly, the length of the lens holder 15 in the Y direction may be smaller than the gap Ly1 of the X slider 13, but substantially equal to the gap Ly2 of the Y slider 14.

Therefore, the upper half of the lens holder 15 may be restricted in the X direction between the side portion 13C and the side portion 13D of the X slider 13, such that the lens holder 15 may not move in the X direction inside the frame of the X slider 13, but can move in the Y direction inside the frame of the X slider 13.

Similarly, the lower half of the lens holder 15 may be restricted in the X direction between the side portion 14A and the side portion 14B of the Y slider 14, such that the lens holder 15 cannot move in the Y direction inside the frame of the Y slider 14, but can move in the X direction inside the frame of the Y slider 14.

That is, when the X slider 13 moves in the X direction, the upper half of the lens holder 15 may be moved while being restricted by the X slider 13. In this case, the lower half of the lens holder 15 may be moved within the range of the gap Lx2 inside the frame of the Y slider 14. Similarly, when the Y slider 14 moves in the Y direction, the lower half of the lens holder 15 may be moved while being restricted by the Y slider 14. In this case, the lower half of the lens holder 15 may be moved within the range of the gap Ly1 inside the frame of the X slider 13.

As shown in FIG. 3, in the lower half (Z2 side) of the lens holder 15 in the thickness, moving members 17 may be provided between the step portions 15a of the lens holder 15 and the second receiving portions 14a of the Y slider. Similarly, moving members 17 may be rollably provided between the step portions 15b of the lens holder 15 and the second receiving portions 14b of the Y slider.

Further, as shown in FIG. 4, in the upper half (Z1 side) of the lens holder 15 in the thickness, small balls 17 may be provided between the step portions 15c of the lens holder 15 and the first receiving portions 13a of the X slider. Similarly, moving members 17 may be rollably provided between the step portions 15d of the lens holder 15 and the first receiving portions 13b of the X slider.

That is, the lens holder 15 may be integrally assembled with the upper X slider and the lower Y slider 14 while being interposed therebetween in the vertical direction. Specifically, the upper half of the lens holder 15 in the thickness direction thereof may be held by the upper X slider, and the lower half thereof may be held by the lower Y slider. In addition, the moving members 17 may be rollably held between the step portions 15a, 15b, 15c, and 15d and the first and second receiving portions 13a, 13b, 14a, and 14b that are opposite to each other.

As shown in FIG. 5, the surfaces of the step portion 15a and the second receiving portion 14a that are opposite to each other and come into contact with the moving members 17 may be flat surfaces that are parallel to each other. Therefore, the lens holder 15 can be maintained horizontally, and thus it may be possible to prevent the lens holder 15 from being inclined while being moved.

The assembly of the X slider 13, the Y slider 14, and the lens holder 15 may be provided inside the case 11. In this instance, a holding member 23A that holds the yoke 21a and the magnet 22a may be provided at one end of the X slider 13 in the X1 direction, and a holding member 23B that holds the yoke 21b and the magnet 22b may be provided at one end of the Y slider 14 in the Y1 direction. The assembly may be provided inside the case 1.

Further, one of the pair of Y shafts 16a and 16b (in this embodiment, the Y shaft 16b) fitted into the elongated grooves 11b of the case 11 may be movably inserted between, for example, the pair of guide pieces 14f that are formed in the lower Y slider. In this way, the Y slider may be guided by the Y shaft 16b so as to be movable in a straight line in the Y direction.

Finally, the X shafts 12a and 12b may be mounted to an upper part of the assembly. The X shafts 12a and 12b may be supported by the support concave portions 11c and the support concave portions 11d, respectively. At the same time, the X shaft 12a may be fitted into shaft support portions 13e and 13f that are formed in generally U shapes in the X slider 13. In this way, the X slider may be guided by the X shaft 12a so as to be movable in a straight line in the X direction. In addition, it may be possible to press the upper surface of the X slider 13 using the X shafts 12a and 12b. Therefore, it may be possible to prevent the assembly from being disassembled.

Next, the operation of the optical image stabilizer will be described. As shown in FIG. 6, for example, a control unit 41, a vibration detecting unit 42, and a driver circuit 43 that can apply a predetermined driving current to the N driving unit 20A and the Y driving unit 208 in response to instructions from the control unit 41 may be provided outside the optical image stabilizer.

Detection signals from the magnetic sensors 31 and 32 may be input to the control unit 41. The magnetic sensor 31 may monitor the position of the X detection magnet m1 of the X slider 13 in the X direction, and the magnetic sensor 32 may monitor the position of the Y detection magnet m2 of the Y slider 14 in the Y direction.

The vibration detecting unit 42 may be composed of an angular velocity sensor (gyro) that may detect an angular velocity, and may be provided in the lens holder 15. An angular velocity signal detected by the vibration detecting unit 42 may be transmitted to the control unit 41, and the control unit 41 may convert the signal into an angle and controls the position of the lens holder 15 on the basis of the angle.

For example, a case in which a camera shake occurs in the X direction will be described. The vibration detecting unit 42 may output an angular velocity signal corresponding to the camera shake to the control unit 41. When receiving the signal from the vibration detecting unit 42, the control unit 41 may calculate the position where the lens holder 15 is shifted in order to correcting the camera shake, and may output a signal corresponding to the shift amount to the driver circuit 43. Then, the driver circuit 43 may apply a driving current corresponding to the shift amount to the coil C1. Then, an electromagnetic force may be generated from the X driving unit 20A, which may cause the X slider 13 to be shifted a predetermined distance in the X direction.

At that time, the control unit 41 may receive a detection signal from the magnetic sensor 31, and may control the driver circuit 43 to apply a driving current to the X driving unit 20A, thereby shifting the X slider in the X direction by a predetermined distance. In this way, the camera shake in the X direction may be corrected.

When a camera shake occurs in the Y direction, similarly, a predetermined driving current may be applied to the coil C2 of the Y driving unit 20B to move the lens holder 15 and the Y slider 14 in the Y direction by a predetermined distance. In this way, it may be possible to correct the camera shake in the Y direction.

Therefore, it is possible to correct an electronic camera shake in the X and Y directions.

As such, in the disclosure, when moving one of the X slider 13 and the Y slider 14, it is may not be necessary to move the other slider, and it may be possible to independently move the X slider 13 and the Y slider 14.

Specifically, when the lens holder 15 is moved in the X direction, the moving members 17 may roll between the side surface 15A of the lens holder 15 and the inner surface of the side portion 14C of the Y slider 14, and the moving members 17 may roll between the side surface 15B of the lens holder 15 and the inner surface of the side portion 14D of the Y slider 14. That is, when the X slider 13 having the lens holder 15 provided therein is moved in the X direction, the small spheres 17 may serve as moving members that allow relative movement between the lens holder 15 and the Y slider 14 in the X direction. In addition, the moving members may be composed of the small spheres 17 reduce a sliding load between the lens holder 15 and the Y slider 14 when the lens holder 15 and the X slider 13 are moved in the X direction. Therefore, it may be possible to smoothly move the lens holder 15 and the X slider 13 having the lens holder 15 provided therein.

Similarly, when the lens holder 15 is moved in the Y direction, the small spheres 17 may roll between the side surface 15C of the lens holder 15 and the inner surface of the side portion 13C of the X slider 13, and the small spheres 17 may roll between the side surface 15D of the lens holder 15 and the inner surface of the side portion 13D of the X slider 13. That is, when the Y slider 14 having the lens holder 15 provided therein is moved in the Y direction, the small spheres 17 may serve as moving members that may allow relative movement between the lens holder 15 and the X slider 13 in the Y direction. In addition, the moving members composed of the small spheres 17 may reduce a sliding load between the lens holder 15 and the X slider 13 when the lens holder 15 and the Y slider 14 are moved in the Y direction. Therefore, it may be possible to smoothly move the lens holder 15 and the Y slider 14 having the lens holder 15 provided therein.

As described above, according to this embodiment, it may be possible to independently move the X slider 13 and the Y slider 14 in the orthogonal direction. In addition, since the sliding load may be reduced during movement, it may be possible to smoothly move the X slider 13 and the Y slider 14. Therefore, it may be possible to reduce the amount of driving current and thus reduce power consumption. Further, since the load applied to the optical image stabilizer may be reduced, it is possible to improve the responsiveness of the optical image stabilizer.

Furthermore, in this embodiment, the small spheres 17 may be used as the moving members, but the moving members are not limited to the small spheres, For example, rollers also may be used as the moving members.

Also, as the moving member, a convex portion with a spherical end may slide on a flat sliding surface. In this case, the convex portions may be provided on the lens holder, and the flat sliding surface may be provided on the X slider or the Y slider. On the contrary, the flat sliding surface may be provided on the lens holder, and the convex portions may be provided on the X slider or the Y slider.

1. An optical image stabilizer comprising:
a lens holder;
an X slider that is movable in an X direction while restricting the movement of the lens holder in the X direction;
a Y slider that is movable in a Y direction orthogonal to the X direction while restricting the movement of the lens holder in the Y direction;
an X driving unit that applies a driving force to move the X slider in an X-axis direction;
a Y driving unit that applies a driving force to move the Y slider in a Y-axis direction; and
moving members that are provided between the lens holder and the X slider and between the lens holder and the Y slider and move one of the X slider and the Y slider relative to the other slider.

2. The optical image stabilizer according to claim 1, wherein the moving members are balls.

3. The optical image stabilizer according to claim 1,
wherein the moving members include convex portions that are formed on one of the lens holder and the X or Y slider and a sliding surface that is formed on the other.

4. The optical image stabilizer according to claim 1,
wherein the X slider includes:
a frame that accommodates the lens holder; and
first receiving portions that protrude from the inner surface of the frame inward, the Y slider includes:
a frame that accommodates the lens holder; and
second receiving portions that protrude from the inner surface of the frame inward,
the lens holder includes step portions that are formed by cutting portions of the side surface thereof, and
the moving members are provided between the first receiving portions of the X slider and the step portions and between the second receiving portions of the Y slider and the step portions.

5. The optical image stabilizer according to claim 1,
wherein the lens holder is supported by the X slider and the Y slider that are opposite to each other in the thickness direction thereof while being interposed therebetween.

6. The optical image stabilizer according to claim 5,
wherein the thickness of the lens holder is equal to or smaller than the sum of the thicknesses of the X slider and the Y slider.

7. The optical image stabilizer according to claim 1, further comprising:
X shafts that guide the X slider in the X direction; and
Y shafts that guide the Y slider in the Y direction,
wherein the X shafts and the Y shafts are opposite to each other with a predetermined distance therebetween in the thickness direction, and
the X slider and the Y slider having the lens holder interposed therebetween are provided between the X shafts and the Y shafts.

8. The optical image stabilizer according to claim 1,
wherein the moving members are rollers.

9. The optical image stabilizer according to claim 1,
wherein the moving members are substantially spherical.

10. The optical image stabilizer according to claim 1,
wherein the moving members are substantially cylindrical.
